(19) United States
(12) Patent Application Publication
(10) Pub. No.: US 2014/0068464 A1
(43) Pub. Date: Mar. 6, 2014

(54) System And Method For Capturing Computer Application-Related Information

(71) Applicant: Massively Parallel Technologies, Inc., Boulder, CO (US)

(72) Inventors: Kevin D. Howard, Tempe, AZ (US); Hassan Khanmohammadbaigi, Menlo Park, CA (US)

(73) Assignee: Massively Parallel Technologies, Inc., Boulder, CO (US)

(21) Appl. No.: 14/015,521

(22) Filed: Aug. 30, 2013

Related U.S. Application Data
(60) Provisional application No. 61/695,126, filed on Aug. 30, 2012.

(51) Int. Cl. G06F 3/0482

(52) U.S. Cl. CPC G06F 3/0482
USPC 715/753

(57) ABSTRACT

A method for capturing information related to a software application. Initially, a current browser display screen is copied into a browser-based application. The browser display screen is then displayed as a popup window including an editing window comprising selectable text and graphics editing options. Text and graphics editing options are provided to annotate the popup window with application information. User information including user name and email address is received, and the application information and associated user information is stored in a database. The annotated display screen is displayed in response to receiving the name of the corresponding annotator.

### BACKGROUND

Many current computer applications have the ability to receive information from the user concerning the operation of the application. This typically takes the form of an automatic error detection and transmission by the application to the application development organization, a survey from the application development organization, an instant messaging system connecting the application user to the application development organization, or an email message, generally via the application vendor's customer support web site. This means that there is no standard way to communicate user information to a development organization. This lack-of-consistency problem is only exacerbated with the advent of web- and cloud-based applications. Furthermore, other than the possibility of having a particular bug fixed, there is no incentive for application users to send anything but bug reports to the software development organization. Thus, new application ideas generated by users of an application are generally not available from within the application itself.

### PROBLEM—APPLICATION INFORMATION CAPTURE

Previous automatic error detection and transmission systems are not amenable to a general solution as they require that the source-code be modified such that error conditions can be detected. This means that every instance of error detection requires intimate knowledge of the underlying code. Surveys and emails are time-consuming to the user and offer little opportunity for the user to quickly and easily describe their idea or concern. Instant messaging systems require the user to input tedious descriptions of their ideas which decreases the number of people willing to create such descriptions.

### SOLUTION/SUMMARY

The presently disclosed methods extend the ideas of social networking to include a software application's user community. A method is disclosed for quickly and easily capturing ideas from, and concerns of, an application's user, while simultaneously providing the incentives needed to motivate the user community to participate in the present change recommendation system.

The present method and system comprises novel information capture models including Internet browser toolbar and environment toolbar embodiments, which comprise methods for capturing both ‘bug’ (error) and non-bug software application information from an application's user base, and for tracking the originators of the application information. These models provide incentives for the application's user base to provide a development organization with a variety of types of information concerning applications developed by the organization.

More specifically, a system and method is disclosed for capturing information related to a software application, and the subsequent storage, discussions about, and/or analytics performed on such captured information. Initially, a current browser display screen, or a non-browser-based application, is copied into a browser-based application. The browser display screen is then displayed as a new window or a popup window including an editing window comprising selectable text and graphics editing options. Text and graphics editing options are provided to annotate the popup window with application information. User (annotator) information including user name and email address is received, and the application information and associated user information is stored in a database for later display of information including user names associated with respective applications that were annotated. Thus, annotated applications can be correlated with their respective development organization as well as with the contributor of a particular annotated application.

### BRIEF DESCRIPTION OF THE DRAWINGS

FIG. 1 is a system diagram showing an exemplary computing environment in which the present system and method operates;

FIG. 2 is a flowchart of a high-level exemplary algorithm of the present method for capturing application information;

FIG. 3 shows an exemplary browser button on an exemplary Internet browser toolbar;

FIG. 4 shows an exemplary editing pop-up window; and

FIG. 5 shows an exemplary MB button display with annotated browser screen.

### DETAILED DESCRIPTION

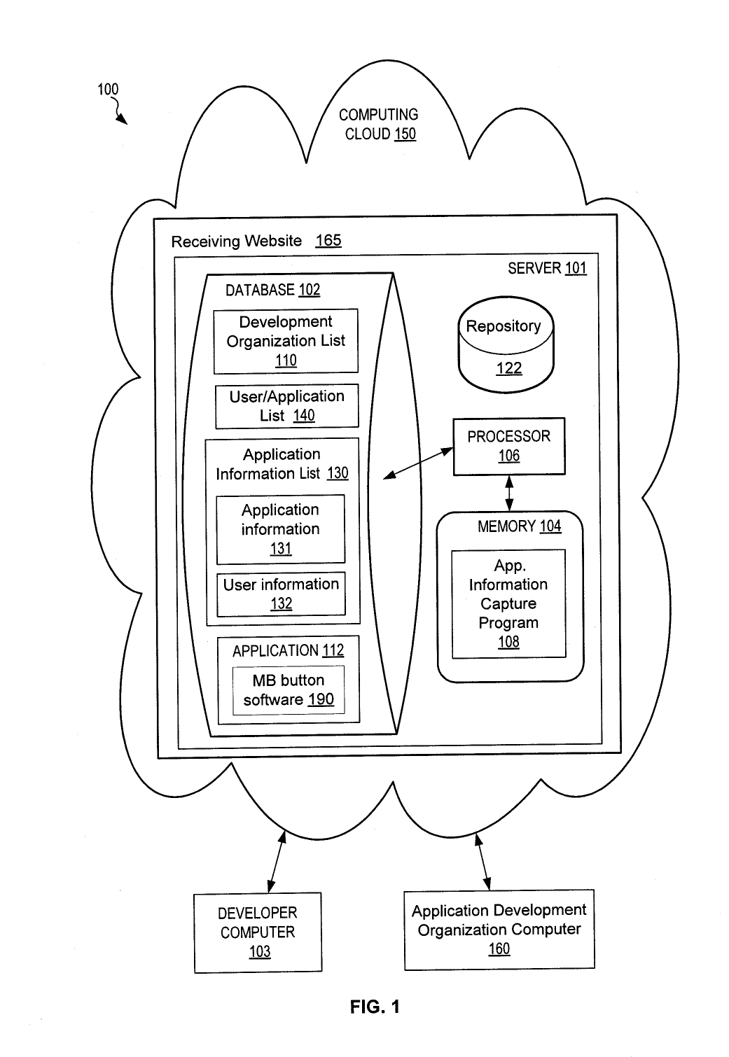

FIG. 1 is a system diagram showing an exemplary development environment 100 in which the present system and method operates. As shown in FIG. 1, environment 100 includes a management server 101 which may be accessed via a receiving website 165. Receiving website 165 can be a centralized website (or web service) that the various web application development organizations can use or the receiving website can be a decentralized website (or web service) associated with a particular application development or application sales organization. Management server 101 provides control for access by developers (using, for example, computer 103), via computing cloud 150 (and/or other communication network, such as the Internet), to developer applications 112 (browser-based or other) and to application development organizations (using, e.g., computer 160). Management server 101 includes a database 102, a memory 104 (e.g., RAM, DRAM, NVM, etc.), and a processor 106. In one embodiment, operation of the present system is controlled by application information capture program 108.

Database 102 is a network data storage device, for example, which is used for storing a development organization list 110, developer applications 112 (only one of which is shown), application information list 130, and user/application list 140. Development organization list 110 contains electronic addresses (URLs or other locating indicia) of development organization computer systems (e.g., computer 160) or websites. List 110 provides a correspondence between the development organization addresses and the applications 112 developed by the organizations. Application information list 130 correlates application information 131 (contributions by users) with respective applications and the names and addresses of the contributors. Thus, annotated applications can be correlated with their respective development organization as well as with the contributor of a particular annotation.

Message repository 122 provides a storage area for user comments and application annotations for a given web site, as well as a place where such annotation can be discussed. In one embodiment, any user may comment on any other's annotations or further annotate a particular contribution.

### Browser Toolbar Embodiment

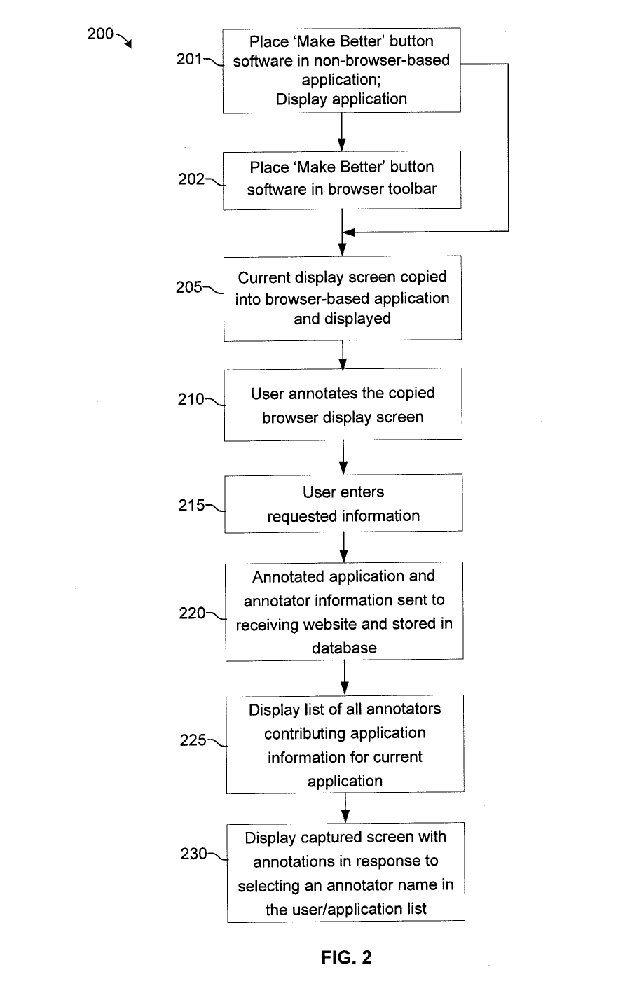

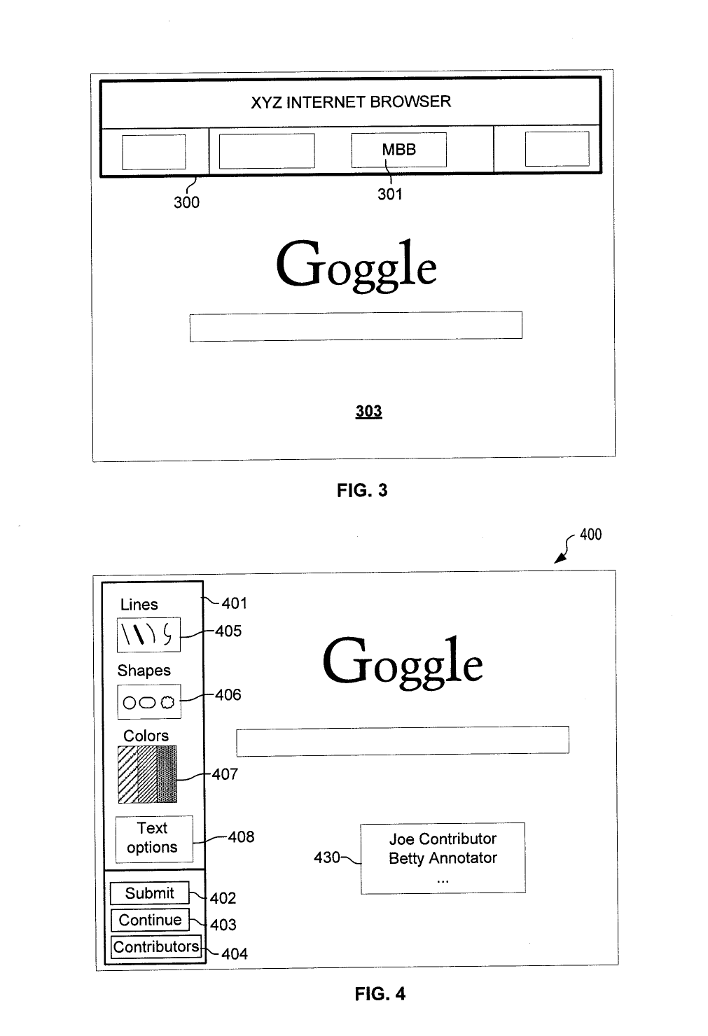

FIG. 2 is a flowchart of a high-level exemplary algorithm 200 of the present method for capturing application-related information 131. FIG. 3 shows an exemplary browser ‘button’ 301 on an exemplary Internet browser toolbar 300 displayed on a browser display screen 303. FIG. 4 shows an exemplary editing pop-up window 401 in browser screen 400. As shown in FIGS. 2 and 3, in the most general embodiment, a graphically-displayed ‘Make it Better’ button 301, hereinafter ‘MB’ button 301, is placed on the toolbar 300 of an Internet browser, e.g., Internet Explorer® or Google Chrome, on an application developer's computer 103, at step 202. In one embodiment, MB button 301 is placed in toolbar 300 by MB button application information capture program 108. MB button 301 is linked to MB button software 190, which provides the functionality described herein. Button 301 can be employed on any web site, not just those that may be viewed as an “application” per se.

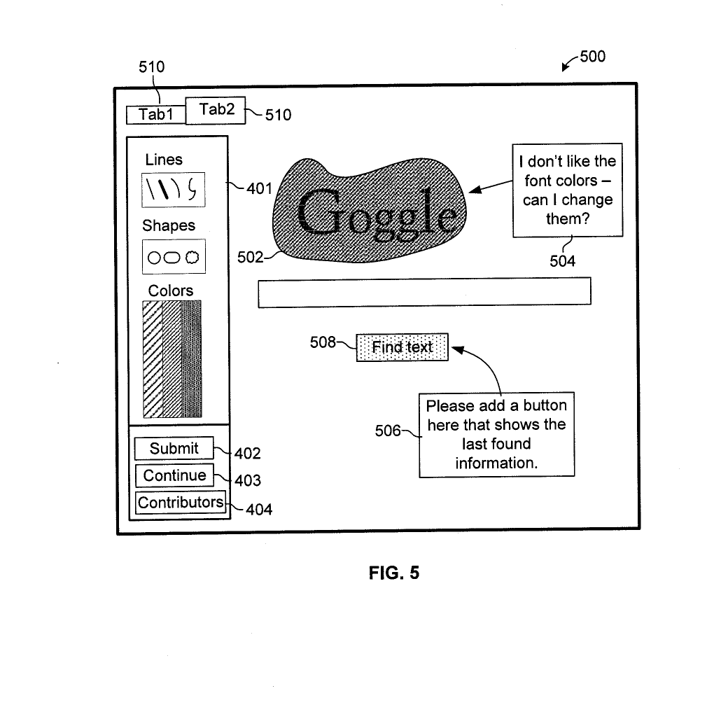

At step 205, selection of MB button 301 causes the current display screen 303 to be copied into a browser-based application 112 and displayed on computer 103 as a popup (or other) window 400, as shown in FIG. 4. In one embodiment, button 301 can be dragged to a user's toolbar. Contained within popup window 400 is an editing window 401 which includes selectable text and graphics editing options, such as selections for line types 405, object shapes 406, colors 407, and text entry and editing options 408. The selectable options allow a user to annotate, i.e., draw or write on, the copied browser display screen, at step 210, as shown in FIG. 5. Both ‘bug’ (error) and non-bug application information 131 may be entered by an application user, as well as recommendations for (other) changes to a particular application 112.

FIG. 5 shows an exemplary display with an annotated browser screen 500. As shown in FIG. 5, at step 210, a user annotates screen 500 with text and/or graphics relating to the currently displayed application 112, using editing window 401. In the FIG. 5 example, a user has added text blocks and associated arrows 504 and 506, as well as a graphic and text ‘button’ 508, and a shaded shape 502 enclosing an area of interest. Selection of a Submit button 402 first causes a screen (not shown) to be displayed which requests user/annotator information 132 including, for example, an annotator name and email address. The requested user information 132 is entered in step 215, and the annotated screen 500 including application information 131 comprising user annotations (e.g., blocks 502, 504, 506, and 508, in FIG. 5) is sent to receiving website 165, along with the requested user information 132, at step 220, where the application information and user/annotator information is stored in list 130 in database 102.

Multiple web pages can be annotated with the selection of a Continue button 403 which returns control back to the web-browser based application 112. The copied page still exists as a separate web-page. If an additional web page is to be annotated, then the annotation is accomplished within a tab 510 of the original (previous) display. Selection of Submit button 402 on any tab 510 causes all annotated displays to be submitted to the receiving web-site 165. Message repository 122 provides an additional mechanism for annotating/commenting on the organization and layout and attributes or general usability of web sites.

The present system allows for acknowledgement of annotator information input contributions. At step 225, selection of a Contributors button 404 generates display 430 (shown in FIG. 4) comprising a user/application list 140 that includes all annotators that contributed to application information 131 for the current application 112, using information in application information list 130. Selecting the name of an annotator in user/application list 140 will cause the captured screen with that user's annotation to be displayed, at step 230. Such ‘bragging rights’ provide an incentive to the user community to help the application development organization improve their offerings. In one embodiment, only the first party of a multiple-user contribution is recognized.

### Environment Toolbar Embodiment

The environment toolbar embodiment operates in basically the same manner as the browser toolbar embodiment, with the significant exception being that the MB button software 190 is placed within the application 112 itself (which is displayed to make the MB button 301 available), as indicated at step 201 in FIG. 2.

For cloud-based software development and deployment platforms, application users in the present development environment ‘know’ the developing organization (via access to the organizations' URLs which are stored in Development Organization List 110), and therefore user application-related input can be sent directly to the appropriate application development organization 160. Furthermore, the application development organization can offer further incentives for users to send suggestions. For example, in a software-as-a-service environment the application development organization can offer some number of free uses of an application that is annotated or some use of another application developed by that organization within the same development/deployment environment.

Having described the invention in detail and by reference to specific embodiments thereof, it will be apparent that modifications and variations are possible without departing from the scope of the invention defined in the appended claims. More specifically, it is contemplated that the present system is not limited to the specifically-disclosed aspects thereof.

What is claimed is:

1. A method for capturing information related to a computer software application executing on an Internet browser comprising:
copying a current browser display screen into the application;
displaying the browser display screen in a window including an editing area comprising selectable text and graphics editing options;
receiving application information in the form of annotations to the display screen generated with the selectable text and graphics editing options;
annotating the display screen using the received annotations;
receiving user information including an annotator name associated with the annotations and corresponding email address;
storing, in a database, the annotated display screen, the application information, and the user information associated with the application; and
displaying a list of all annotators contributing the application information for the application, using the application information and the user information stored in the database.

2. The method of claim 1, including:
generating an application information list that correlates said application information with respective applications and the names and addresses of corresponding said annotators; and
displaying the annotated display screen in response to receiving an annotator name in the application information list.

3. The method of claim 1, including initially placing a graphically-displayed button on a toolbar of the browser, wherein selection of the button causes the browser display screen to be displayed in the window.

4. The method of claim 1, including displaying the annotator name in conjunction with the name of the application that was annotated.

5. The method of claim 1, further including:
associating, in a development organization list, applications developed by development organizations and addresses of the organizations; and
using the development organization list to correlate and display annotated applications and respective organizations.

6. The method of claim 1, wherein the browser display screen is copied into the application in response to selection of a graphically-displayed button placed in a toolbar of the browser.

7. The method of claim 1, including generating a development organization list containing electronic addresses of development organization computer systems and websites, wherein the ist development organization list provides a correspondence between the addresses of the development organizations and the applications developed by respective said organizations.

8. The method of claim 7, including generating an application information list that correlates the application information with respective applications and the names and addresses of the corresponding annotators.

9. A method for capturing information related to a computer software application executing on a non-browser-based application comprising:
copying a current display screen into the application;
displaying the display screen in a window including an editing area comprising selectable text and graphics editing options;
receiving application information in the form of annotations to the display screen generated with the selectable text and graphics editing options;
annotating the display screen using the received annotations;
receiving user information including an annotator name associated with the annotations and corresponding email address;
storing, in a database, the annotated display screen, the application information, and the user information associated with the application; and
displaying a list of all annotators contributing the application information for the application, using the application information and the user information stored in the database.

10. The method of claim 9, including:
generating an application information list that correlates said application information with respective applications and the names and addresses of corresponding said annotators; and
displaying the annotated display screen in response to receiving an annotator name in the application information list.

11. The method of claim 9, including initially placing a graphically-displayed button on a toolbar of the application, wherein selection of the button causes the display screen to be displayed in the window.

12. The method of claim 9, including displaying the annotator name in conjunction with the name of the application that was annotated.

13. The method of claim 9, further including:
associating, in a development organization list, applications developed by development organizations and addresses of the organizations; and
using the development organization list to correlate and display annotated applications and respective organizations.

14. The method of claim 9, wherein the browser display screen is copied into the application in response to selection of a graphically-displayed button placed in a toolbar of the browser.

15. The method of claim 9, including generating a development organization list containing electronic addresses of development organization computer systems and websites, wherein the ist development organization list provides a correspondence between the addresses of the development organizations and the applications developed by respective said organizations.

16. The method of claim 9, including generating an application information list that correlates the application information with respective applications and the names and addresses of the corresponding annotators.

17. A method for capturing information related to a computer software application executing on an Internet browser comprising:
placing a graphically-displayed button on a toolbar of the browser;
copying a current browser display screen into the application in response to selection of the button;
displaying the browser display screen in a window including an editing area comprising selectable text and graphics editing options;
receiving application information in the form of annotations to the display screen generated with the selectable text and graphics editing options;
annotating the display screen using the received annotations; and
displaying the annotated display screen in response to receiving an annotator name.

18. The method of claim 17, including displaying the annotator name in conjunction with the name of the application that was annotated.

19. The method of claim 17, further including:
associating, in a development organization list, applications developed by development organizations and addresses of the organizations; and
using the development organization list to correlate and display annotated applications and respective organizations.

20. The method of claim 17, including generating an application information list that correlates the application information with respective applications and the names and addresses of the corresponding annotators.
